(19) United States
(12) Patent Application Publication
(10) Pub. No.: US 2004/0028142 A1
(43) Pub. Date: Feb. 12, 2004

(54) Video decoding system

(76) Inventor: Eung Tae Kim, Suwon-si (KR)

Correspondence Address: BIRCH STEWART KOLASCH & BIRCH, PO BOX 747, FALLS CHURCH, VA, 22040-0747, US

(21) Appl. No.: 10/633,641

(22) Filed: Aug. 5, 2003

(30) Foreign Application Priority Data
Aug. 8, 2002 (KR) 2002-46830

(51) Int. Cl. H04N 7/12

(52) U.S. Cl. 375/240.25; 375/240.2

(57) ABSTRACT

An MPEG-2 video decoding system simultaneously decodes two or more HD-class MPEG sequences using a single video decoder, and reduces memory capacity and bandwidth. According to the video decoding system, a buffer size is reduced by efficiently sharing a video buffer, and a great reduction of a gate size can be obtained by integrating a VLD unit and a picture controller, and by integrating a motion compensation unit and a memory interface, respectively. Also, two or more HD-class MPEG sequences are displayed in the form of a PIP or a split screen. In the case of the PIP display, a DTV main picture is displayed in a non-compression mode, and a DTV sub-picture is displayed in a ¼-compression mode. In the case of the split-screen display, the DTV main picture and the DTV sub-picture are displayed in a ½-compression mode.

This application claims the benefit of the Korean Application No. P 2002-46830 filed on Aug. 8, 2002, which is hereby incorporated by reference.

### BACKGROUND OF THE INVENTION

1. Field of the Invention

The present invention relates to an MPEG-2 video decoding system applied to the application fields of a digital TV (television receiver) or a digital videoconference system.

2. Discussion of the Related Art

A general MPEG-2 video decoding system, as shown in FIG. 1, includes a TP (Transport) decoder 101, a video decoder 102, a memory controller 500, an external memory 600, a VDP (Video Display Processor) 700, host interface (not illustrated), etc.

Here, the video decoder 102 includes a buffer 102a, a VLD (Variable Length Decoding) unit 102b, an IQ (Inverse Quantization) unit 102c, an IDCT (Inverse Discrete Cosine Transform) unit 102d, an adder 102e, and an MC (Motion Compensation) unit 102f.

The operation of the general MPEG-2 video decoding system as constructed above will now be explained.

Since transmitted MPEG-2 video and audio signals and additional data bitstream are multiplexed, the TP decoder 101 separates the input signal into a video signal, an audio signal, and additional data. The separated video bitstream is outputted to the VLD unit 102b through the buffer 102a of the video decoder 102.

The VLD unit 102b separates the video bitstream into motion vectors, quantization values, and DCT (Discrete Cosine Transform) coefficients by variable-length-decoding the video bitstream, and outputs the motion vectors (MV) to the motion compensation unit 102f and the quantization values and the DCT coefficients to the IQ unit 102c, respectively.

The IQ unit 102c performs an inverse quantization of the DCT coefficients according to the quantization values, and outputs the inverse-quantized DCT coefficients to the IDCT unit 102d. The IDCT unit 102d performs an IDCT of the inverse-quantized DCT coefficients in the unit of an 8×8 block to match the MPEG-2 video syntax and outputs the IDCT-transformed coefficients to the adder 102e.

The motion compensation unit 102f performs a motion compensation of the present pixel values using the motion vectors and the previous frame stored in the external memory 600, and outputs the motion-compensated pixel values to the adder 102e. The adder 102e restores the complete picture that corresponds to the final pixel values by adding the IDCT-transformed values and the motion-compensated values, and stores the restored picture in the external memory 600 through the memory controller 500. That is, in the case of an I-picture (Intra-picture), the IQ/IDCT results are directly stored in the external memory 600, and in the case of a P-picture (Predictive-picture) or a B-picture (Bi-directional picture), the motion-compensated blocks and the IDCT results are added together and stored in the memory 600. The picture stored in the memory 600 is converted as to match a display format by the VDP 700, and then displayed on a screen of a display device.

At this time, the external memory comprises a DRAM (or SDRAM) in order to store the input bitstream and the frame buffers for the motion compensation.

Especially, in the case of the video decoder 102, the external memory 600 is mainly used for the write/read of a bitstream for video decoding, the read of data required for motion compensation, the write of decoded data, and the read of data to be displayed, and sends/receives data through the memory controller.

At this time, in order to support an MP @HL mode in the MPEG-2 standard, a buffer size of about 10 Mbits is required, and the maximum allowable bit rate reaches about 80 Mbits/sec. In order to store an HD-class picture of three frames using a bus having a size of 64 bits, an external memory of 76.8 Mbits is required. Accordingly, in the case of the MPEG-2 decoder, an external memory of about 96 ˜128 Mbits including the bit-buffer size is required.

The digital TVs produced up to now mainly support diverse functions related to a PIP (Picture In Picture) function, but, for example, such functions are limited to types of DTV+NTSC, DTV+PC (external input), etc. According to the recent tendency, a high-end DTV performs a DTV+DTV type display using two channels. For this, it is required to multi-decodes HD-class MPEG-2 video signals and to simultaneously display the decoded video signals.

However, the appliance according to the related art has the drawbacks in that in order to decode two HD-class video signals, two MPEG-2 video decoding chips should be used or an expensive chip having two video decoder parts should be used.

FIG. 2 illustrates a block diagram of a related art video decoder for decoding two HD-class video signals.

Referring to FIG. 2, two MPEG-2 video decoders are separately provided, and a picture control unit is provided for each video decoder in order to simultaneously decode the two HD-class video signals. The construction of FIG. 2 has the advantage that the video decoding operation can be separately and easily controlled, but has the disadvantage that the gate size of the chip is increased with the cost thereof increased.

Consequently, in consideration of the limitations of a memory, the chip size, and the bandwidth of a data bus, it is required to develop an efficient video decoding chip that can decode two HD-class video signals.

### SUMMARY OF THE INVENTION

Accordingly, the present invention is directed to a video decoding system that substantially obviates one or more problems due to limitations and disadvantages of the related art.

An object of the present invention is to provide a video decoding system which can provide diverse picture services by simultaneously decoding two HD-class MEPG-2 sequences using a single video decoding chip.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a video decoding system includes a plurality of transport (TP) decoders for receiving compressed bitstreams of a plurality of channels, parsing and outputting the respective video bitstreams, a video decoder for receiving the HD-class video bitstreams of the plurality of channels through the TP decoders, and decoding a plurality of video frames for a display frame period in the unit of a picture, an external memory for storing video-decoded frames for a motion compensation in the video decoder and a video display of the plurality of channels, a video display processor (VDP) for reading out the video frame data of the plurality of channels decoded by the video decoder from the external memory, converting the video frame data to match a display format, and simultaneously displaying the video frames of the plurality of channels on a screen of a display device, and a memory interface for interfacing the video decoder, the external memory and the VDP so that the video decoder decodes and displays the plurality of HD-class video frames for the display frame period.

The video decoder includes a video buffer for temporarily storing the video bitstreams of the plurality of channels outputted through the plurality of TS decoders in the unit of a picture and then outputting the video bitstreams, a variable-length decoder (VLD) unit for separating the video bitstreams of the plurality of channels outputted through the video buffer into motion vectors, quantization values and DCT coefficients by variable-length-decoding the video bitstreams in the unit of a picture, a plurality of inverse quantization (IQ) units for inverse-quantizing the DCT coefficients of the respective channels in accordance with the corresponding quantization values, a plurality of inverse discrete cosine transform (IDCT) units for receiving the DCT coefficients inverse-quantized by the IQ unit, dividing sub-blocks in a macro block including the inverse-quantized DCT coefficients into a plurality of groups, and performing a pipelined IDCT of the groups, a motion compensation unit for performing a motion compensation of present pixel values in the unit of a picture using the motion vectors outputted from the VLD unit and a previous frame stored in the external memory, an adder for adding IDCT-transformed values outputted from the respective IDCT units and motion-compensated values outputted from the motion compensation unit, and a picture control unit for controlling the video buffer, the VLD unit, the adder, and the motion compensation unit in the unit of a picture so that other video frames in the display frame period are decoded.

The memory interface includes a down-sampling unit for down-sampling an output of the adder in horizontal and vertical directions according to picture and display types, and storing a result of down-sampling in the external memory, and an up-sampling unit for up-sampling data readout from the memory in a horizontal direction during the motion compensation, and outputting a result of up-sampling to the motion compensation unit.

The down-sampling unit performs a 1/2-reduction of resolution of the respective pictures in the horizontal direction or performs a ½-reduction of resolution of the respective pictures in the horizontal and vertical directions in accordance with the display type of the data outputted from the adder.

The down-sampling unit does not perform a reduction of a DTV main picture, but performs a ½-reduction of resolution of a DTV sub-picture in the horizontal and vertical directions if the display type is a PIP type composed of a DTV main display and a DTV sub-display.

The down-sampling unit performs a ½-reduction of resolution of a DTV main picture and a DTV sub-picture in the horizontal direction only if the display type is a split-screen type composed of a DTV main display and a DTV sub-display.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a block diagram of a video decoding system for a single video display according to the related art;

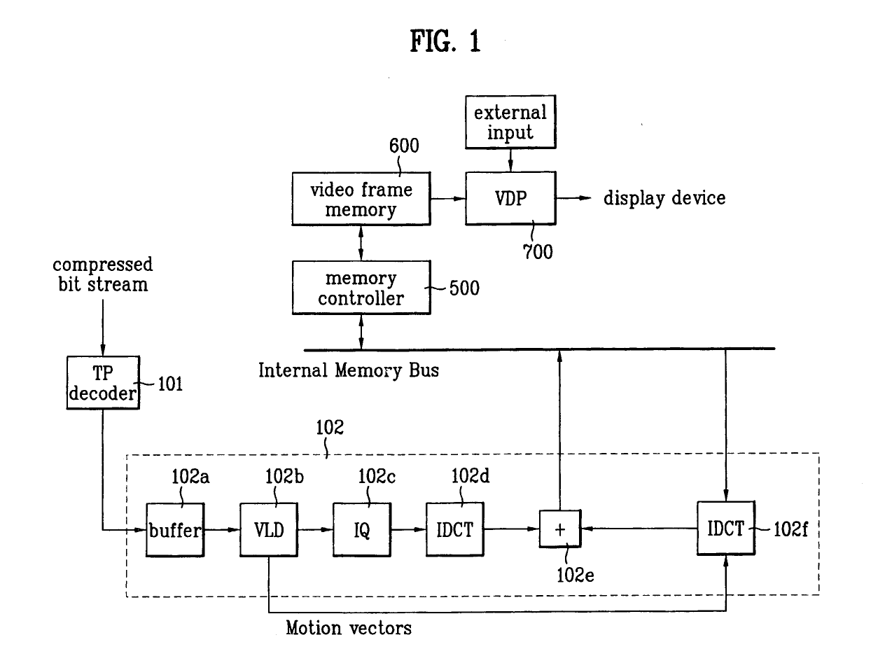

FIG. 2 illustrates a block diagram of a video decoding system for a dual video display according to the related art;

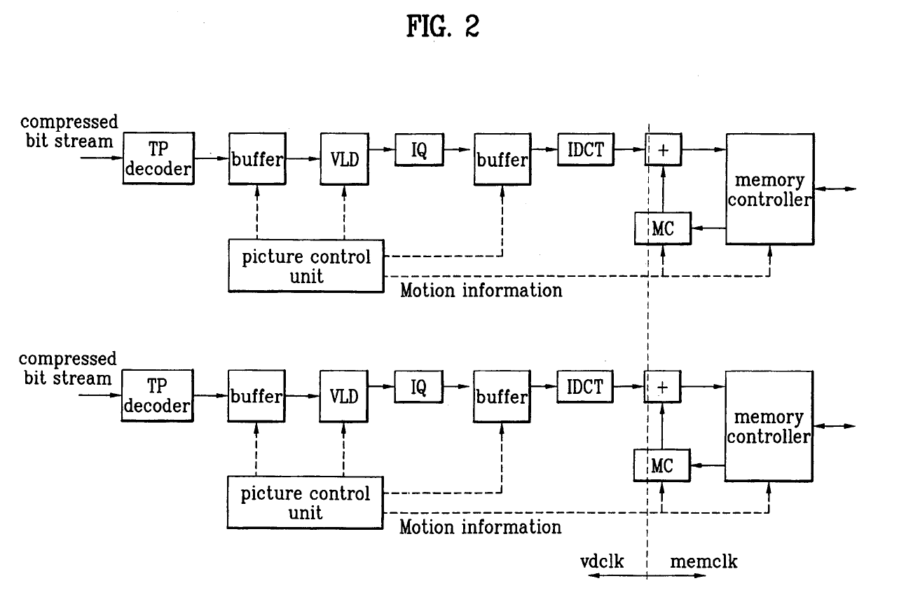

FIG. 3 illustrates a block diagram of a video decoding system according to the present invention;

FIG. 4 illustrates an example of a pipelined IDCT of respective blocks of a macro block performed by the IDCT unit of FIG. 3;

FIG. 5 illustrates a timing diagram of an interface between a video decoder and a VDP for a single video display during a frame decoding according to the present invention;

FIG. 6 illustrates a timing diagram of an interface between a video decoder and a VDP for a dual video display during a frame decoding according to the present invention;

FIG. 7 illustrates a timing diagram of an interface between a video decoder and a VDP for a dual video display during a field decoding according to the present invention; and

FIGS. 8a and 8b illustrate examples of compression type according to the display mode of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

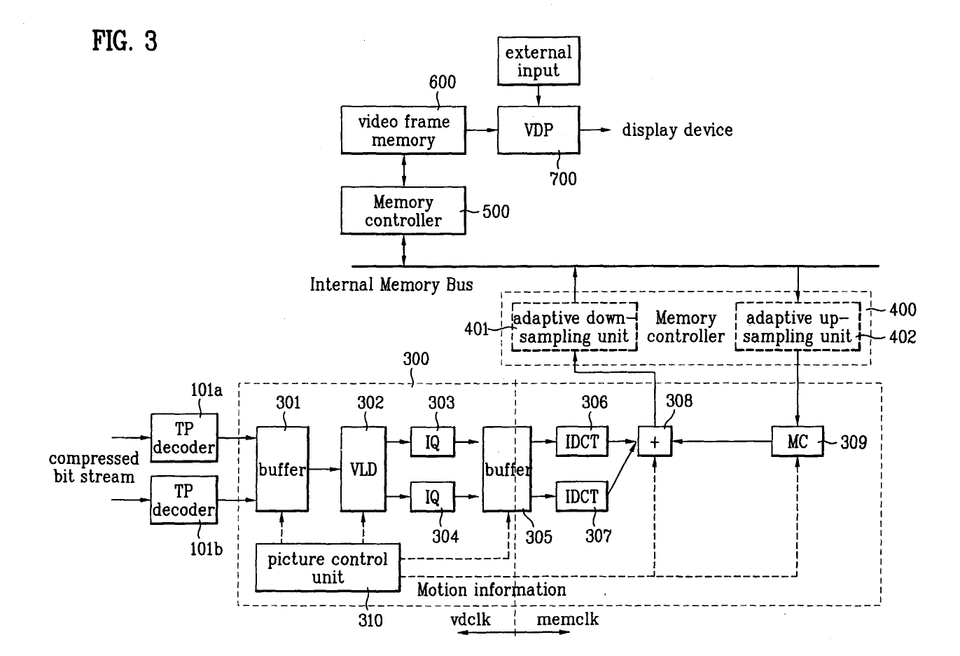

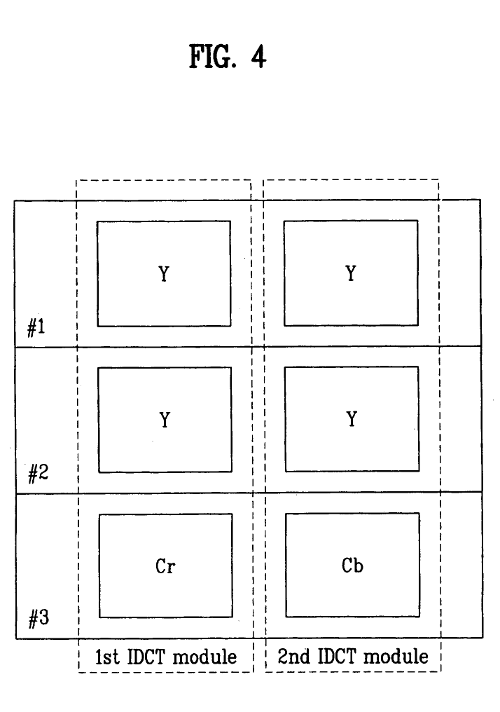

FIG. 3 illustrates a block diagram of a video decoding system for decoding two HD-class video signals according to the present invention, and FIG. 4 illustrates an example of a pipelined IDCT of respective blocks of a macro block performed by the IDCT unit of FIG. 3.

The video decoding system according to the present invention, as shown in FIG. 3, includes first and second TP decoders 101a and 101b for simultaneously decoding two HD-class video signals, a video decoder 300, and a memory interface 400.

The video decoder 300 comprises a first buffer 301, a VLD unit 302, first and second IQ unit 303 and 304, a second buffer 305, first and second IDCT units 306 and 307, an adder 308, a motion compensation unit 309, and a picture controller 310.

According to the present invention, a buffer size is reduced by efficiently sharing the first buffer 301 that is the video buffer, and a great reduction of a gate size can be obtained by integrating the VLD unit 302 and the picture controller 310, and by integrating the motion compensation unit 309 and the memory interface 400, respectively. Also, for a high-rate IDCT data process that is important to the performance of the video decoder 300, two IDCT units and two IQ units are provided.

Also, the memory interface 400 includes a down-sampling unit 401, in order to keep a good picture quality and reduce a memory capacity, for performing different reductions in horizontal and vertical directions in accordance with picture and display types, and outputting results of reductions to the VDP 700 for display and to the external memory 600 for motion compensation, and an up-sampling unit 402 for up-sampling the date readout from the memory 600, and outputting up-sampled data to the motion compensation unit 309.

In the video decoding system according to the present invention as constructed above, the first and second TP decoders 101a and 101b have the same construction and function. The first or second TP decoder 101a or 101b separates the input MPEG-2 compressed bitstream into video, audio and additional data by demultiplexing the MPEG-2 compressed bitstream, and outputs the separated video bitstream to the first buffer 301 of the video decoder 300. That is, two HD-class video bitstreams are outputted to the first buffer 301 through the first and second TP decoders 101a and 101b.

The first buffer 301 is a video buffer, which temporarily stores the video bitstream outputted from the first and second TP decoders 101a and 101b, and then outputs the video bitstream to the VLD unit 302 of the video decoder 300 in order to decode the video bitstream coded at a variable rate to a fixed rate.

For example, it is assumed that the two HD-class video signals are outputted through the first and second TP decoders 101a and 101b, and at this time, output signals of the first and second decoders 101a and 101b are defined as first and second channel signals, respectively.

The first buffer 301 outputs the first channel signal to the VLD unit 302 in the unit of a picture, and then outputs the second channel signal to the VLD unit 302 in the unit of a picture.

That is, the picture control unit 310 controls the first buffer 301, the VLD unit 302, the second buffer 305, the adder 308, and the motion compensation unit 309 in the unit of a picture so as to decode the two different video frames in a display frame period.

The VLD unit 302 separates the video bitstream outputted from the first buffer 301 at a fixed rate into the motion vectors, the quantization values, and the DCT coefficients by variable-length-decoding the video bitstream, and outputs the motion vectors to the motion compensation unit 309 and the quantization values and the DCT coefficients to the first and second IQ units 303 and 304. That is, the VLD unit 302 performs the VLD in the unit of a picture with respect to the first channel signal to output the VLD-transformed first channel signal to the first IQ unit 303, and then performs the VLD in the unit of a picture with respect to the second channel signal to output the VLD-transformed second channel signal to the second IQ unit 304.

The first IQ unit 303 performs an inverse quantization of the DCT coefficients of the first channel signal to output the inverse-quantized DCT coefficients to the second buffer, and the second IQ unit 304 performs an inverse quantization of the DCT coefficients of the second channel signal to output the inverse-quantized DCT coefficients to the second buffer.

At this time, since the first and second IDCT units 306 and 307 connected to the output terminals of the second buffer 305 perform the IDCT in the unit of a block, the second buffer 305 divides 6 8×8 blocks in the macro block into two groups, and outputs the divided blocks to the first and second IDCT units 306 and 307, and the first and second IDCT units 306 and 307 perform the IDCT of the DCT coefficients inverse-quantized in the unit of a 8×8 block to match the MPEG-2 video syntax, and output the IDCT-transformed coefficients to the adder 308.

In the case of the two HD-class video signals, the frequency of performing the 8×8 IDCT in one frame period is 2×8160×6=97920. Also, the amount of data to be processed in one frame is 75.2 Mbits (=97920×64×12 bits). Consequently, in the worst case, the IDCT requires a processing ability of 225.6 Mbits/sec.

In practice, in order to more efficiently reduce the overhead such as the data processing time of the VLD, the IQ process, etc., as shown in FIG. 4, the first and second IDCT units 306 and 307 divide 6 8×8 blocks in the macro block into two groups, and perform a pipelined IDCT with respect to the two groups. By this job distribution to the first and second IDCT modules 306 and 307, the IDCT processing time in the macro block can be reduced by almost half.

Also, if a DDR (Double Data Rate) SDRAM having a 64-bit data width of more than 135 MHz is used as the external memory 600, two HD-class video signals can be processed through one motion compensation unit 309 and the memory interface 400 using a memory data bus of 128 bits and of 135 MHz inside the chip. For reference, an SDRAM of 64 bits requires the whole bandwidth of more than 145 MHz.

Specifically, the motion compensation unit 309 performs a motion compensation of the present pixel values using the motion vectors in the unit of a picture and the previous frame stored in the external memory 600 under the control of the picture control unit 310, and outputs the motion-compensated values to the adder 308. The adder 308 restores the complete picture that corresponds to the final pixel values by adding the values IDCT-transformed by the first and second IDCT units 306 and 307 and the motion-compensated values, and stores the restored picture in the external memory 600 through the memory interface 400. The restored picture is converted to match the display format by the VDP 700, and then displayed on the screen of the display device.

Meanwhile, in order to reduce the memory capacity and the bandwidth, as shown in FIG. 3, the memory interface 400 includes the down-sampling unit 401 and the up-sampling unit 402 for the memory compression. The down-sampling unit 401 performs a ½-reduction of resolution of the respective picture in the horizontal direction, or performs a ½-reduction of resolution of the respective picture in the horizontal and vertical directions in accordance with the display type of the data outputted from the adder 308. Also, since the motion compensation is performed using the I- or P-picture as a reference frame, the up-sampling unit 402 performs a two-times up-sampling of the data readout from the external memory 600 in the horizontal direction, or performs a two-time up-sampling of the data in the horizontal and vertical directions to output the up-sampled data to the motion compensation unit 309.

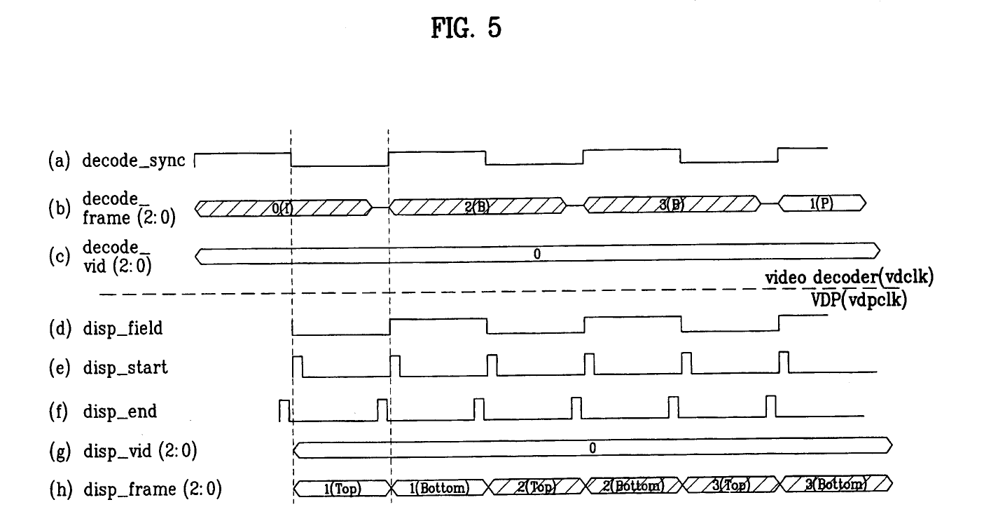

Meanwhile, FIG. 5 illustrates a timing diagram of the interface between the video decoder 300 and the VDP 700 for a single video display during the frame decoding operation according to the present invention.

In FIG. 5, ‘(a) decode_sync’ of the video decoder 300 represents a period required for decoding a frame, and coincides with the display field sync signal ‘(d) disp_field’ of the VDP 700. That is, a video frame is decoded before a field to match the period decode_sync, and is displayed to match the display field signal disp_field. ‘(b) decode_frame (2:0)’ represents a video frame that is presently decoded and written in the memory 600, and ‘(c) decode_vid (2:0)’ represents a video ID signal for identifying video signals decoded during a multi-decoding operation.

Also, ‘(e) disp_start’ and ‘(f) disp_end’ of the VDP 700 represent signals for informing the start and the end of displaying the corresponding frame to the video decoder 300. The VDP 700 receives signals of ‘(g) disp_vid (2:0) and ‘(h) disp_frame (2:0)’ from the picture control unit 310 of the video decoder 300, reads the video data from the corresponding area of the frame memory 600, and displays the video data on the screen of the display device.

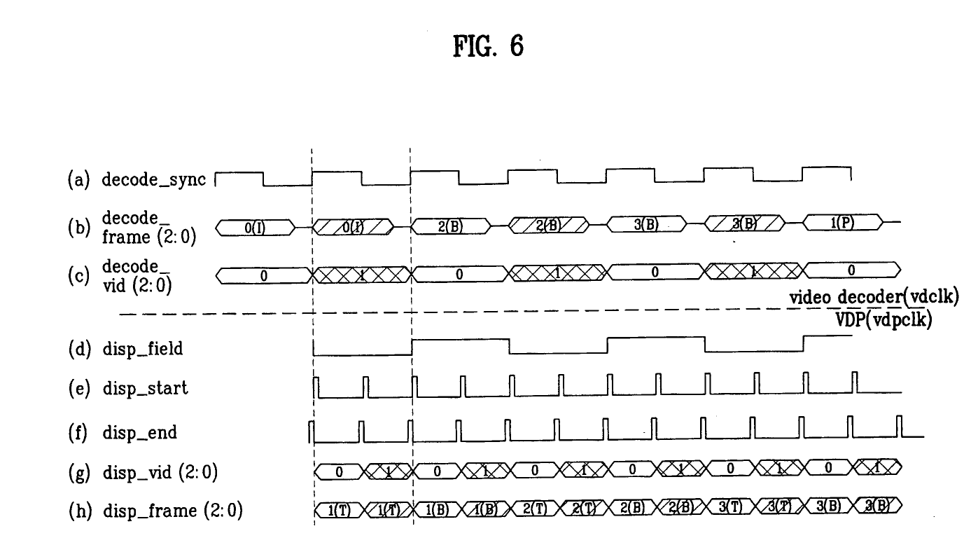

FIG. 6 illustrates a timing diagram of the interface between the video decoder 300 and the VDP 700 for a dual video display during the frame decoding operation according to the present invention.

FIG. 6 shows how one video decoder 300 displays two video pictures for one frame period.

First, it can be known that a period of ‘(a) decode_sync’ is a half of a period of the display field sync signal ‘(d) disp_field’ of the VDP 700. In comparison to FIG. 5, the video decoder 300 decodes one video frame for the period of ‘(a) decode_sync’, and this is the same as the decoding of two frames for the period (i.e., one frame period) of ‘(d) disp_field’. That is, the video decoder can display two pictures for one frame period. Also, it can be known that ‘(c) decode_vid (2:0)’ is changed to ‘0’ and ‘1’. For example, if the ‘decode_vid (2:0)’ is ‘0’, the video frame of the first channel is decoded and displayed, while if the ‘decode_vid (2:0)’ is ‘1’, the video frame of the second channel is decoded and displayed.

The picture control unit 310 of the video decoder 300 transmits the information of ‘(g) disp_vid’ and ‘(h) disp_frame” to the VDP 700 according to the ‘disp_start’ signal and the ‘disp_end’ signal of the VDP 700 as shown in FIG. 6, and thus two pictures are displayed for one frame period. At this time, it is necessary to match the top and bottom fields of the two video signals.

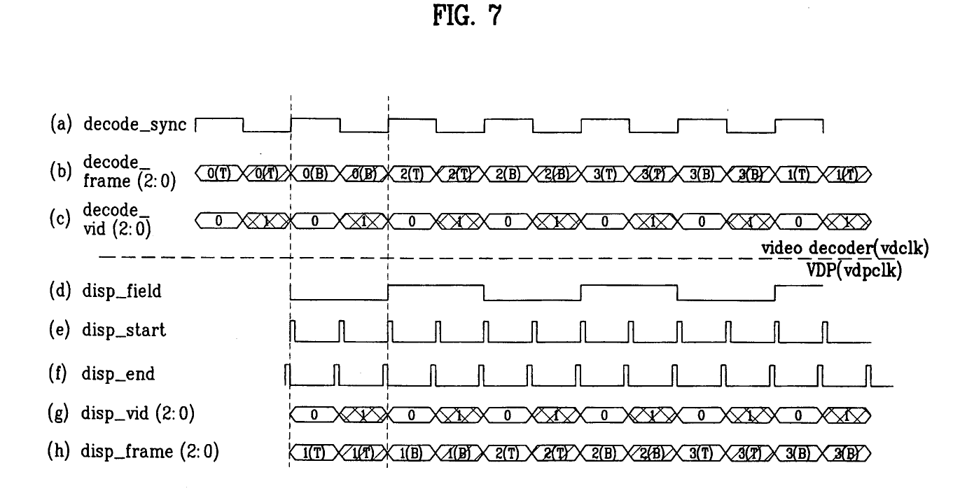

FIG. 7 illustrates a timing diagram of the interface between the video decoder 300 and a VDP 700 for a dual video display during a field decoding operation, i.e., in the case that the input data is encoded to a field picture.

In FIG. 7, it can be known that the period of ‘(a) decode_sync’ is a half of the period of the display field sync signal ‘(d) disp_field’ of the VDP 700. The video decoder 300 decodes one video ID for a half periof of decode_sync’, and provides the decoded information to the VDP 700. For example, for a half period of the decode_sync, the top field of the first channel is decoded, and then for the other half period of the decode_sync, the top field of the second channel is decoded. Then, for a half period of the next decode_sync, the bottom field of the first channel is decoded, and then for the other half period of the next decode_sync, the bottom field of the second channel is decoded. Consequently, for two periods of the decode_sync, the top and bottom fields of the first and second channels are all decoded, and this corresponds to a period of the disp_sync.

That is, one field picture is decoded and displayed to match the ‘(e) disp_start’ signal and the ‘(f) disp_end’ signal.

Meanwhile, In the case of one HD-class frame, a memory capacity of about 25.6 Mbits is required. In the case of the MPEG-2 video decoding, a memory for three frames is required, and this corresponds to the memory capacity of about 76.8 Mbits. As a result, for two HD-class video signals, a memory capacity of about 154 Mbits is required. Also, in consideration of a memory area for the TP bitstream, a memory area for the OSD and video display process, three or more memories of 64 Mbits are required.

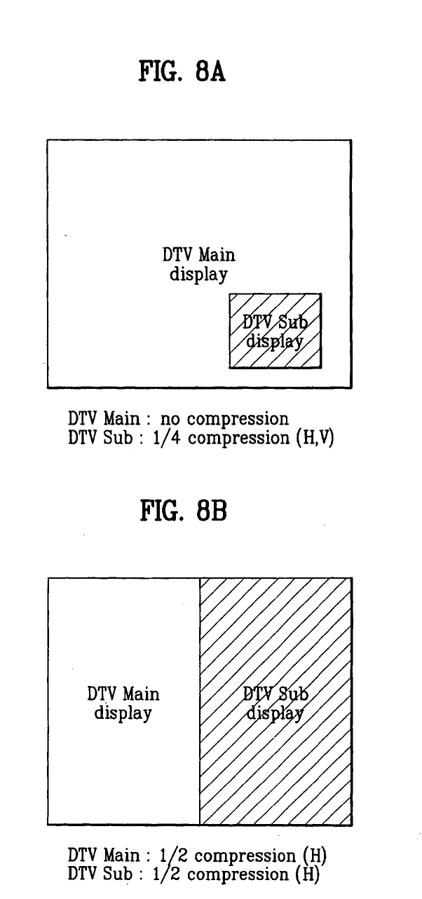

FIGS. 8a and 8b illustrate examples of compression type according to the display mode for displaying two HD-class videos according to the present invention.

Since the memory capacity increases according to the display type, the picture control unit 310, in order to reduce the cost according to the memory increase and to provide a more efficient memory bandwidth, performs an adaptive compression of the decoded data by controlling the down-sampling unit 401 and the up-sampling unit 402 of the memory interface 400.

Specifically, as shown in FIG. 8a, in the case of the PIP display composed of a DTV main display and a DTV sub-display, the picture control unit 310, in order to reduce the memory capacity and the bandwidth, performs a ¼-compression of the sub-picture, i.e., ½-compression in the horizontal direction and ½-compression in the vertical direction, through the down-sampling unit 401, stores and displays the compressed sub-picture. At this time, the DTV main picture is not compressed. In other words, the DTV main picture is displayed in a non-compression mode.

FIG. 8b shows the split-screen display composed of a DTV main display and a DTV sub-display. At this time, in order to reduce the memory capacity and the bandwidth, the picture control unit 310 performs a ½-compression of the main picture and the sub-picture in the horizontal direction, respectively, through the down-sampling unit 401, stores and displays the compressed main picture and the sub-picture. In this case, the DTV main picture is ½-compressed, and the STV sub-picture is also ½-compressed. For example, the memory capacity required for the display of two video frames by the field decoding operation as shown in FIG. 7 is 128 Mbits.

As described above, in decoding the two video signals, the memory interface 400 controls the memory 600 so as to reduce the size of the frame memories according to the display types.

The embodiment of FIG. 3 includes two TP decoders 101a and 101b, two IQ units 303 and 304, and two IDCT units 306 and 307 in order to decode two channel signals. However, in the case of decoding three or more channel signals, the number of TP decoders, the IQ units and the IDCT units is increased in proportion to the number of channels, and the three or more channel signals are simultaneously decoded using one video decoder.

The present invention is a basic technology which is essential to the application fields of a digital TV or a videoconference system, and can provide a high-performance digital video decoder for receiving, multi-decoding and displaying several video signals on one screen with the technical competitiveness strengthened.

As described above, according to the video decoding system of the present invention, two or more HD-class MPEG sequences are simultaneously decoded using a single video decoder, and then displayed in the form of a PIP or a split screen. At this time, a buffer size is reduced by efficiently sharing the video buffer, and a great reduction of a gate size can be obtained by integrating the VLD unit and the picture controller, and by integrating the motion compensation unit and the memory interface, respectively. That is, the video decoding system according to the present invention can reduce the cost according to the reduction of the memory capacity and the chip size in comparison to the existing system having two video decoders.

Also, the video decoding system according to the present invention can reduce the memory capacity and the bandwidth by operating the DTV main picture in a non-compression mode and operating the DTV sub-picture in a ¼-compression mode through the down-sampling unit when the display type is the PIP type.

Also, the video decoding system according to the present invention can reduce the memory capacity and the bandwidth by operating the DTV main picture and the DTV sub-picture in a ½-compression mode through the down-sampling unit when the display type is the split-screen type.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A video decoding system comprising:
a plurality of transport decoders for receiving compressed bitstreams of a plurality of channels, parsing and outputting the respective video bitstreams;
a video decoder for receiving the HD-class video bitstreams of the plurality of channels through the transport decoders, and decoding a plurality of video frames for a display frame period in the unit of a picture;
an external memory for storing video-decoded frames for a motion compensation in the video decoder and a dual video display;
a video display processor (VDP) for reading out the video frame data of the plurality of channels decoded by the video decoder from the external memory, converting the video frame data to match a display format, and simultaneously displaying the video frames of the plurality of channels on a screen of a display device; and
a memory interface for interfacing the video decoder, the external memory and the VDP so that the video decoder decodes and displays the plurality of HD-class video frames for the display frame period.

2. The video decoding system of claim 1, wherein the video decoder comprises:
a video buffer for temporarily storing the video bitstreams of the plurality of channels outputted through the plurality of TS decoders in the unit of a picture, and then outputting the video bitstreams;
a variable-length decoder (VLD) unit for separating the video bitstreams of the plurality of channels outputted through the video buffer into motion vectors, quantization values and DCT coefficients by variable-length-decoding the video bitstreams in the unit of a picture;
a plurality of inverse quantization (IQ) units for inverse-quantizing the DCT coefficients of the respective channels in accordance with the corresponding quantization values;
a plurality of inverse discrete cosine transform (IDCT) units for receiving the DCT coefficients inverse-quantized by the IQ unit, dividing sub-blocks in a macro block including the inverse-quantized DCT coefficients into a plurality of groups, and performing a pipelined IDCT of the groups;
a motion compensation unit for performing a motion compensation of present pixel values in the unit of a picture using the motion vectors outputted from the VLD unit and a previous frame stored in the external memory;
an adder for adding IDCT-transformed values outputted from the respective IDCT units and motion-compensated values outputted from the motion compensation unit; and
a picture control unit for controlling the video buffer, the VLD unit, the adder, and the motion compensation unit in the unit of a picture so that other video frames in the display frame period are decoded.

3. The video decoding system of claim 2, wherein the number of the transport decoders, the IQ units or the IDCT units is 2.

4. The video decoding system of claim 3, wherein the memory interface comprises:
a down-sampling unit for performing a reduction of an output of the adder in horizontal and vertical directions according to picture and display types, and storing the reduced data in the external memory; and
an up-sampling unit for up-sampling data readout from the memory in a horizontal direction during the motion compensation, and outputting the up-sampled data to the motion compensation unit.

5. The video decoding system of claim 4, wherein the down-sampling unit performs a ½-reduction of resolution of the respective pictures in the horizontal direction, or performs a ½-reduction of resolution of the respective pictures in the horizontal and vertical directions, respectively, in accordance with the display type of the data outputted from the adder.

6. The video decoding system of claim 4, wherein the down-sampling unit does not perform a reduction of a DTV main picture, but performs a ½-reduction of resolution of a DTV sub-picture in the horizontal and vertical directions if the display type is a PIP type composed of a DTV main display and a DTV sub-display.

7. The video decoding system of claim 4, wherein the down-sampling unit performs a ½-reduction of resolution of a DTV main picture and a DTV sub-picture in the horizontal direction only if the display type is a split-screen type composed of a DTV main display and a DTV sub-display.

8. The video decoding system of claim 1, wherein if the input data is encoded to a frame picture and a dual video display is performed, the picture control unit controls so that a period of a decode_sync required for one frame decoding of the video decoder becomes a half period of a disp_field required for one frame display of the VDP, and the plurality of video frames are decoded and displayed for one period of the disp_field.

9. The video decoding system of claim 1, wherein if the input data is encoded to a frame picture and a dual video display is performed, the picture control unit controls so that a period of a decode_sync required for one frame decoding of the video decoder becomes a half period of a disp_field required for one frame display of the VDP, and so that a top field of one channel is decoded for a half period of the decode_sync and a top field of another channel is decoded for the other half period of the decode_sync, while a bottom field of the one channel is decoded for a half period of a next decode_sync and a bottom field of the another channel is decoded for the other half period of the next decode_sync.

10. The video decoding system of claim 1, wherein the external memory comprises a double data rate (DDR) SDRAM having a 64-bit data width of more than 135 MHz.
